(19) United States
(12) Patent Application Publication
(10) Pub. No.: US 2009/0199021 A1
(43) Pub. Date: Aug. 6, 2009

(54) POWER MANAGEMENT MODULE FOR CENTRAL PROCESSING UNIT

(75) Inventors: Wei-Yi Chu, Taipei City (TW); Tin-Chen Ko, Taipei City (TW)

Correspondence Address: J C PATENTS, INC., 4 VENTURE, SUITE 250, IRVINE, CA, 92618, US

(73) Assignee: INVENTEC CORPORATION, Taipei City (TW)

(21) Appl. No.: 12/027,187

(22) Filed: Feb. 6, 2008

(51) Int. Cl. G06F 1/26

(52) U.S. Cl. 713/300

(57) ABSTRACT

A power management module for a CPU is provided. The power management module includes a basic input/output system (BIOS) chip, a power stripping module, and a DC-DC converter module. The BIOS chip is coupled to the CPU, and has a power consumption information of the CPU. The power stripping module is coupled to BIOS chip, and is adapted for outputting a power control signal according to the power consumption information of the CPU. The DC-DC converter module is coupled to the CPU and the power stripping module. The DC-DC converter module includes a plurality of DC-DC converters. The power control signal is accorded to determine a quantity of the DC-DC converters for enabling, so as to provide a suitable power to the CPU.

### BACKGROUND OF THE INVENTION

1. Field of the Invention

The present invention generally relates to a power management module, and more particularly, to a power management module for a central processing unit (CPU).

2. Description of Related Art

Recently, as the calculation capability of CPUs becomes faster and faster, the CPUs correspondingly consume more and more power. Typically, in order to allow a CPU to achieve its optimal performance, a DC-DC converter module is required to provide sufficient power to the CPU. A conventional DC-DC converter module is discussed in general below.

FIG. 1 is a conventional DC-DC converter module for a CPU. Referring to FIG. 1, in order to satisfy the demand of a CPU 10 for greater power, there is shown a DC-DC converter module 20 for providing power to the CPU 10, a pulse width modulation (PWM) controller 40. The DC-DC converter module 20 includes four sets of DC-DC converters 31 through 34. The PWM controller 40 is adapted to generate PWM signals PWM1 through PWM4 respectively provided to the DC-DC converters 31 through 34. Phases of the PWM signals PWM1 through PWM4 are different one from another. The DC-DC converters 31 through 34 then respectively provide power to the CPU 10 according to the PWM signals PW1 through PWM4.

Therefore, suppose the CPU 10 is featured with a relative high calculation capability and thus consumes much power, e.g., about 130 W, the DC-DC converters 31 through 34 should provide power of different phases to the CPU 10 to maintain the CPU 10 to perform with the optimal performance. However, when the CPU 10 is one having only a relative low calculation capability, it consumes a lower power, e.g., 60 W or 80 W. In this case, if the DC-DC converters 31 through 34 keep providing power of different phases to the CPU 10, power would be unnecessarily wasted.

### SUMMARY OF THE INVENTION

Accordingly, the present invention is directed to a power management module for a CPU, which is adapted for power saving.

The present invention provides a power management module for a CPU. The power management module includes a basic input/output system (BIOS) chip, a power stripping module, and a DC-DC converter module. The BIOS chip is coupled to the CPU, and contains a power consumption information of the CPU. The power stripping module is coupled to the BIOS chip, and is adapted for outputting a power control signal according to the power consumption information of the CPU. The DC-DC converter module is coupled to the CPU and the power stripping module. The DC-DC converter module includes a plurality of DC-DC converters. The power control signal is accorded to determine a quantity of the DC-DC converters for enabling, so as to provide a suitable power to the CPU.

According to an embodiment of the present invention, the DC-DC converter module further includes a PWM controller, a decoder and a switch module. The PWM controller is coupled to each of the DC-DC converters, for providing a PWM signal thereto. The decoder is coupled to the power stripping module, and is adapted to generate a plurality of switching signals according to the power control signal. The switch module includes a plurality of switches, respectively coupled between output terminals of the DC-DC converters and the CPU, each for determining whether to provide a power to the CPU thereby. According to an aspect of the embodiment, the switches are metal oxide semiconductor field effect transistors (MOSFETs), or bipolar junction transistors (BJTs). According to another aspect of the embodiment, the power stripping module includes a baseboard management controller (BMC) or a complex programmable logic device (CPLD) for generating the power control signal.

According to an embodiment of the present invention, the DC-DC converter module further includes a PWM controller. The PWM controller is coupled to each DC-DC converter, for determining whether to provide a PWM signal to the DC-DC converter according to the power control signal, so as to determine a quantity of DC-DC converters for enabling.

According to an embodiment of the present invention, the power stripping module communicates with the DC-DC converter module via an inter-integrated circuit (I2C) bus. According to an aspect of the embodiment, the BIOS chip communicates with the CPU via a low pin count (LPC) interface, or a firmware hub (FWH). According to another aspect of the embodiment, the chipset includes a north bridge chip and a south bridge chip. The north bridge chip is coupled to the CPU. The south bridge chip is coupled to the north bridge chip and the BIOS chip.

The power management module of the present invention employs the power stripping module, and thus is adapted to acquire a power consumption information of the CPU from the BIOS chip. The DC-DC converter module determines the quantity of the DC-DC converters for enabling according to the power consumption information of the CPU, and thus providing a suitable power to the CPU, so as to save power consumption.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a conventional DC-DC converter module for a CPU.

FIG. 2 is a schematic diagram illustrating a power management module for a CPU according to a first embodiment of the present invention.

FIG. 3 is an isometric diagram illustrating a chipset, a power stripping module, and a DC-DC converter module according to the first embodiment of the present invention.

FIG. 4 is an isometric diagram illustrating a DC-DC converter and a switch module according to the first embodiment of the present invention.

FIG. 5 is a schematic diagram illustrating different PWM signals according to the first embodiment of the present invention.

FIG. 6 is a schematic diagram illustrating a power management module for a CPU according to a second embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

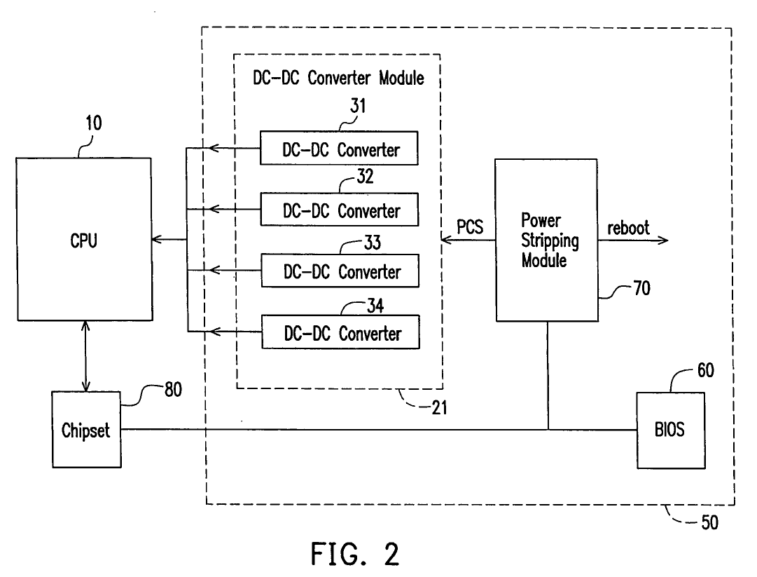

FIG. 2 is a schematic diagram illustrating a power management module for a CPU according a first embodiment of the present invention. Referring to FIG. 2, there is shown a power management module 50 for a CPU 10. The power management module 50 for the CPU 10 includes a BIOS chip 60, a power stripping module 70, and a DC-DC converter module 21. The CPU 10 is coupled to a chipset 80. The CPU 10 is adapted to communicate with other devices via the chipset 80. The BIOS chip 60 is coupled to the CPU 10 by the chipset 80. The BIOS chip 60 communicates with the chipset 80 via an interface which can be either a low pin count (LPC) interface, or a firmware hub (FWH).

When the CPU 10 is initially installed to a mainboard (not shown), and the computer is booted for the first time, the BIOS chip 60 acquires and stores information of the CPU 10, e.g., a power consumption information. The power stripping module 70 is coupled to the BIOS 60 and the DC-DC converter module 21, and is adapted to generate a power control signal PCS according to the power consumption information of the CPU 10, and thereby setups the DC-DC converter module 21. The power stripping module 70 communicates with the DC-DC converter module 21 via an interface such as an inter-integrated circuit (I2C) bus bus. A dynamic adjustment of the power provided by the DC-DC converter module 21 to the CPU 10 often causes a deviation of voltage level, the power stripping module 70 may emit a reboot signal “reboot”, and re-set the DC-DC converter module 21 when rebooting the computer.

The DC-DC converter module 21 is coupled to the CPU 10 and the power stripping module 70. The DC-DC converter module 21 includes a plurality of DC-DC converters. In the current embodiment, it is exemplified with four DC-DC converters 3-1 through 34 for illustration. However, it should not be construed as any restriction to the scope of the present invention. As the computer is rebooted, the DC-DC converter module 21 determines a quantity of the DC-DC converters 31 through 34 for enabling, according to the power control signal PCS, so as to provide a suitable power for the CPU 10. In such a way, the DC-DC converter module 21 achieves the object of power saving by supplying suitable power to the CPU according to the type of the CPU. A process of determining the quantity of the DC-DC converters 31 though 34 is to be illustrated in more details below.

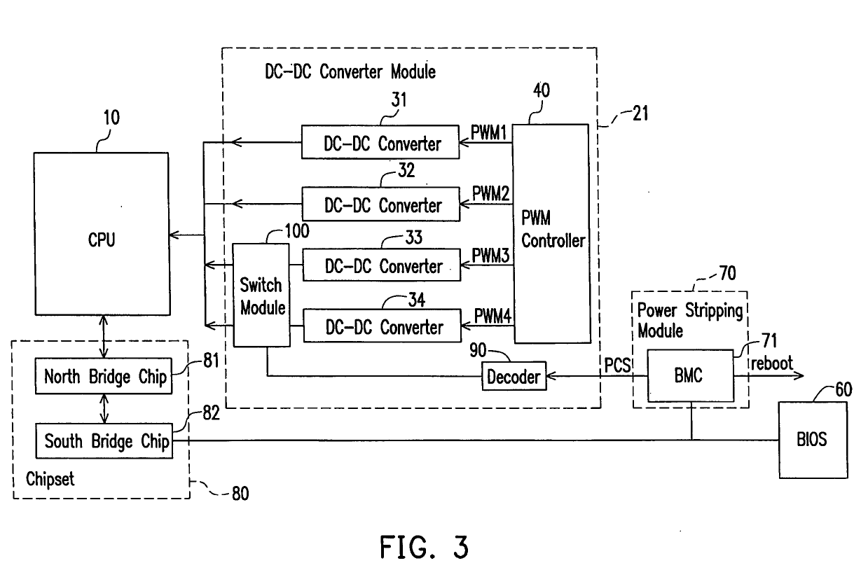

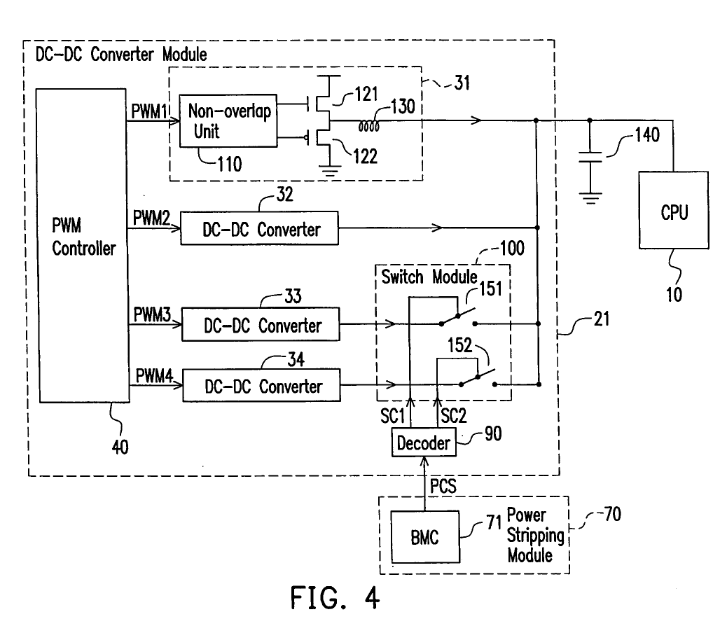

FIG. 3 is an isometric diagram illustrating a chipset, a power stripping module, and a DC-DC converter module according the first embodiment of the present invention. FIG. 4 is an isometric diagram illustrating a DC-DC converter and a switch module of the first embodiment of the present invention. Referring to FIGS. 2, 3, and 4 together, in the current embodiment, the chipset 80 includes a north bridge chip 81 and a south bridge chip 82. The north bridge chip 81 is coupled to the CPU 10. The south bridge chip 82 is coupled to the north bridge chip 81 and the BIOS chip 60. The power stripping module 70 includes a baseboard management controller (BMC) 71 for generating the power control signal PCS.

On the hand, the DC-DC converter module 21 further includes a PWM controller 40, a decoder 90, and a switch module 100. The switch module 100 includes switches 151 and 152. According to an aspect of the embodiment, the switches 151 and 152 are either MOSFETs or BJTs.

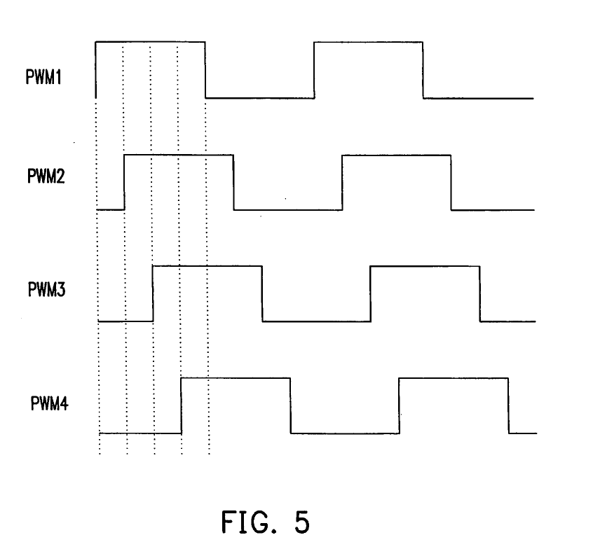

The PWM controller 40 is coupled to the DC-DC converters 31 through 34 for outputting PWM signals PWM1 through PWM4 to the DC-DC converters 31 through 34. The PWM signals PWM1 through PWM4 are different in phase respectively. FIG. 5 is a schematic diagram illustrating different PWM signals according to the first embodiment of the present invention. In the current embodiment, the DC-DC converters 31 through 34 are exemplified as composed of same components, and therefore the structures of the DC-DC converters 31 through 34 are to be illustrated below taking the DC-DC converter 31 as an example.

The DC-DC converter 31 includes a non-overlap unit 110, an upper transistor 121, a lower transistor 122 and an inductor 130. The non-overlap unit 110 is adapted to convert the PWM signal PWM1 into a set of non-overlap signals for controlling the upper transistor 121 and the lower transistor 122 to avoid simultaneous conduction of the upper transistor 121 and the lower transistor 122, which causes a large leakage current. Further, the inductor 130 and a capacitor 140 are adapted to store power in accordance with the operations of the upper transistor 121 and the lower transistor 122, so as to achieve a DC power conversion. The other DC-DC converters 32 through 34 are similar with the DC-DC converter 31 and are not to be iterated hereby.

However, it should be noted, that in the current embodiment, the decoder 90 is coupled to the BMC 71, which is adapted to generate switching signals SC1, SC2 according to the power control signal PCS so as to control the conduction status of the switches 151 and 152. The switches 151 and 152 are respectively coupled between output terminals of the DC-DC converters 33 and 34 and the CPU 10, for determining whether the DC-DC converters 33 and 34 provide power to the CPU 10. In other words, if the power consumed by the CPU 10 is not much, e.g., 60 W or 80 W, the switches 151 and 152 can be shut off by the switching signals SC1 and SC2, and thus the DC-DC converters 33 and 34 are disabled for avoiding power waste. Otherwise, if the power consumed by the CPU 10 is much, e.g., 130 W, the switches 151 and 152 can be turned on by the switching signals SC1 and SC2, and thus the DC-DC converters 33 and 34 are enabled for allowing the CPU 10 to achieve its best performance. In such a way, the CPU 10 can achieve its best performance while saving power when necessary.

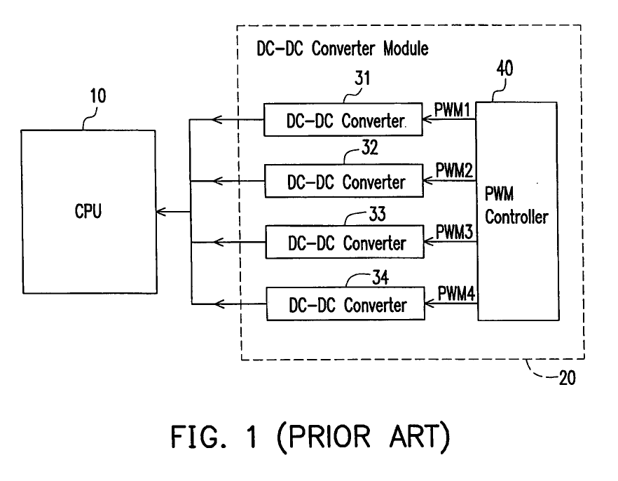

Experiments have been made for evaluating the performance of power saving according to the embodiment of the present invention. Table 1 is a comparison giving power efficiencies of a conventional CPU and a CPU having the power management module according to the present invention. Referring to FIGS. 1, 2, and table 1, it can be learnt that regardless of how much the CPU 10 consumes, the conventional DC-DC converter 20 adopts four phases for simultaneously supplying power to the CPU 10 for maintaining the CPU to work with the best performance. However, when the CPU demands only a small power, e.g., 60 W or 80 W, power will be unnecessarily wasted.

On the contrary, when the CPU 10 consume a power of 80 W, the power management module according to the embodiment of the present invention disables the DC-DC converter 34, and therefore only three DC-DC converters are enabled. In this case, compared to the conventional, the current embodiment enhances about 2 to 4% about power efficiency. When the CPU 10 consume a power of 60 W, the power management module according to the embodiment of the present invention temporarily disables the DC-DC converters 33 and 34, and therefore only two DC-DC converters are enabled. In this case, comparing to the conventional, the current embodiment enhances about 6 to 10% about power efficiency.

TABLE 1
Comparison of power efficiencies of a CPU having a present power
management module with a conventional CPU

| | | Quantity of | Power | |
|---|---|---|---|---|
| | Power | DC-DC | Efficiency of | Power |
| | Consumption | Converters | CPU under | Efficiency of |
| | Information of | For | an Operation | CPU under |
| | CPU | Enabling | Mode | an Idle Mode |
| Conventional | 130 W | 4 | 85% | 70% |
| | 80 W | 4 | 82% | 70% |
| | 60 W | 4 | 79% | 66% |
| Current | 80 W | 3 | 86% | 72% |
| Embodiment | 60 W | 2 | 85% | 76% |

It should be noted that although a preferred embodiment of the power management module for CPU according to the present invention has been illustrated above, those skilled in the art should be aware of that different manufacturers made different designs about power management modules for CPUs. As such, the application of the present invention should not be restricted by the first embodiment described above. If only a power management module for CPU is featured in that a quantity of DC-DC converters for enabling is determined according to a power consumption information of the CPU, the power management module is within the scope of the present invention.

### Second Embodiment

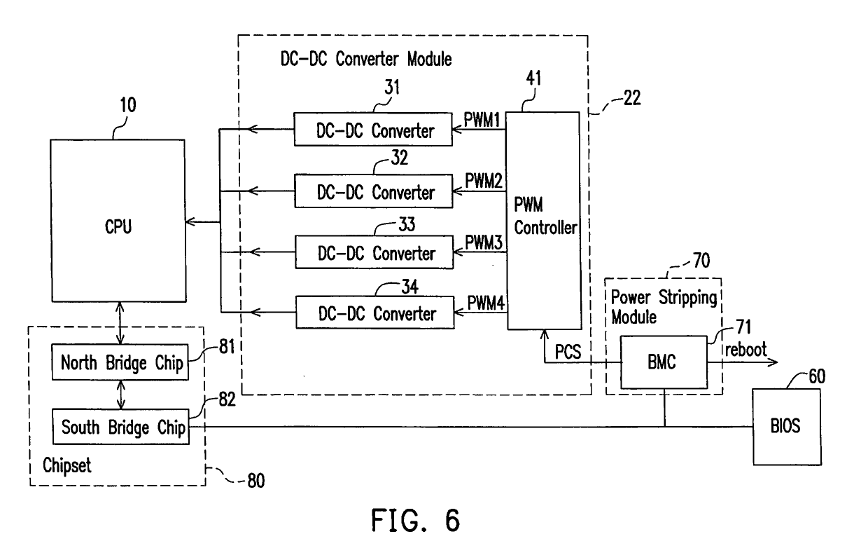

FIG. 6 is a schematic diagram illustrating a power management module for a CPU according a second embodiment of the present invention. In the second embodiment, the same reference numbers are used in the drawings and the description to refer to the same or like parts as exhibited in the first embodiment. Referring to FIGS. 3 and 6 together, there is shown a PWM controller 41 of the DC-DC converter 21 for determining whether to output the PWM signals PWM1 through PWM4 respectively according to the power control signal PCS provided by the BMC 71, so as to determine the quantity of DC-DC converters for enabling.

In more detail, when the CPU 10 consumes a power of 80 W, the PWM controller 41 may suspend the output of the PWM signal PWM4, and therefore there are three DC-DC converters enabled. When the CPU 10 consumes a power of 60 W, the PWM controller 41 may suspend the output of the PWM signals PWM3 and PWM4, and therefore there are two DC-DC converters enabled. In such a way, the second embodiment can similarly achieve a same performance as the first embodiment, while even saving the hardware cost of the decoder 90 and the switch module 100 as shown in FIG. 3.

Referring to FIGS. 3 and 6, as illustrated in the first and the second embodiments, a BMC 71 is employed by the power stripping module 70 for generating the power control signal PCS. While according to another aspect of the above embodiments, a complex programmable logic device (CPLD) is alternatively employed by the power stripping module 70 for generating the power control signal PCS.

In summary, the power management module according to the present invention is adapted for determining the quantity of DC-DC converters for enabling according to a power consumption information of a CPU, for supplying suitable power to the CPU, and therefore is capable of not only maintaining the calculation capability of the CPU, but also saving power.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A power management module for a central processing unit (CPU), comprising:
a basic input/output system (BIOS) chip, coupled to the CPU, comprising a power consumption information of the CPU;
a power stripping module, coupled to the BIOS chip, for outputting a power control signal according to the power consumption information of the CPU; and
a DC-DC converter module, coupled to the CPU and the power stripping module, comprising a plurality of DC-DC converters, and being adapted to determine a quantity of the DC-DC converters for enabling according to the power control signal, so as to provide a suitable power to the CPU.

2. The power management module according to claim 1, wherein the DC-DC converter module comprises:
a pulse width modulation (PWM) controller, coupled to each of the DC-DC converters, for providing a PWM signal thereto;
a decoder, coupled to the power stripping module, for generating a plurality of switching signals according to the power control signal; and
a switch module, comprising a plurality of switches respectively coupled between output terminals of the DC-DC converters and the CPU, each for determining whether to provide a power to the CPU.

3. The power management module according to claim 2, wherein the switches comprise metal oxide semiconductor field effect transistors (MOSFETs), or bipolar junction transistors (BJTs).

4. The power management module according to claim 2, wherein the power stripping module comprises a baseboard management controller (BMC) coupled to the PWM controller for generating the power control signal.

5. The power management module according to claim 2, wherein the power stripping module comprises a complex programmable logic device (CPLD) coupled to the PWM controller for generating the power control signal.

6. The power management module according to claim 1, wherein the DC-DC converter module further comprises:
a PWM controller, coupled to each DC-DC converter, for determining whether to provide a PWM signal to the DC-DC converter according to the power control signal, so as to determine a quantity of the DC-DC converters for enabling.

7. The power management module according to claim 6, wherein the power stripping module comprises a BMC coupled to the PWM controller for generating the power control signal.

8. The power management module according to claim 6, wherein the power stripping module comprises a CPLD coupled to the PWM controller for generating the power control signal.

9. The power management module according to claim 1, wherein the power stripping module communicates with the DC-DC converter module via an inter-integrated circuit (I2C) bus.

10. The power management module according to claim 1, wherein the BIOS chip communicates with the CPU via a chipset.

11. The power management module according to claim 10, wherein the BIOS chip communicates with the chipset via a low pin count (LPC) interface.

12. The power management module according to claim 10, wherein the BIOS chip communicates with the chipset via a firmware hub (FWH).

13. The power management module according to claim 10, wherein the chipset comprises:
a north bridge chip, coupled to the CPU; and
a south bridge chip, coupled to the north bridge chip and the BIOS chip.
